(19) United States
(12) Patent Application Publication
(10) Pub. No.: US 2020/0201038 A1
(43) Pub. Date: Jun. 25, 2020

(54) SYSTEM WITH MULTIPLE DISPLAYS AND METHODS OF USE

(71) Applicant: Real View Imaging Ltd., Yokneam (IL)

(72) Inventors: Shaul Alexander GELMAN, Raanana (IL); Igal IANCU, Haifa (IL); Aviad KAUFMAN, Zikhron-Yaakov (IL); Carmel POTSCHILD, Ganei-Tikva (IL)

(73) Assignee: Real View Imaging Ltd., Yokneam (IL)

(21) Appl. No.: 16/613,442

(22) PCT Filed: May 10, 2018
(86) PCT No.: PCT/IL2018/050509

§ 371 Date: Nov. 14, 2019

Related U.S. Application Data
(60) Provisional application No. 62/506,045, filed on May 15, 2017.

(51) Int. Cl. G02B 27/01; G06F 3/01; G02B 27/00

(52) U.S. Cl. CPC G02B 27/0103; G06F 3/011; G02B 27/0093; G02B 2027/0185; G02B 27/0179; G02B 2027/0174; G02B 27/0172

(57) ABSTRACT

A system with multiple displays, including a first, three-dimensional display, a second display, and a computer for coordinating displaying a scene using the first display to display a first portion of the scene in three dimensions and using the second display to display a second portion of the scene. Related apparatus and methods are also described.

### RELATED APPLICATIONS

This application claims priority from U.S. Provisional Patent Application No. 62/506,045 filed on 15 May 2017.

This application is related to:

PCT Patent Application Number PCT/IL2017/050226 of Gelman et al.;

PCT Patent Application Number PCT/IL2017/050224 of Gelman et al.; and

PCT Patent Application Number PCT/IL2017/050228 of Gelman et al.

The contents of all of the above applications are incorporated by reference as if fully set forth herein.

### FIELD AND BACKGROUND OF THE INVENTION

The present invention, in some embodiments thereof, relates to a system including a holographic display and an additional display and, more particularly, but not exclusively, to a holographic head mounted display and an additional non-holographic display.

The disclosures of all references mentioned above and throughout the present specification, as well as the disclosures of all references mentioned in those references, are hereby incorporated herein by reference.

### SUMMARY OF THE INVENTION

An aspect of some embodiments of the invention includes displaying a holographic image using a first, three-dimensional (3D) holographic display, and displaying an additional image, either 3D holographic or not, using a second, additional display, and apparently transferring an object or part of the object from one of the displays to the other. In some embodiments the apparent transfer is performed by a computer coordinating displaying the object between the first display and the second display, or coordinating displaying a portion of the object between the first display and the second display. In some embodiments, a user provides a command to transfer the object between the displays. In some embodiments, the user makes a gesture of touching an object displayed floating in space by the first, 3D holographic display, and apparently pushing the object toward the second display, and the computer coordinates displaying the object moving toward the second display, and optionally eventually displaying the object by the second display.

The term “three dimensional display” in all its grammatical forms is used throughout the present specification and claims to mean a display which can potentially display a scene to appear three-dimensional. In some embodiments, the three dimensional display may display a three dimensional image of a scene without any depth, by which the three dimensional display effectively displays a two dimensional image. Some non-limiting examples of a three dimensional display include a holographic display, a head mounted holographic display, a stereoscopic display, a head mounted stereoscopic display, and an augmented reality display arranged to display in three dimensions.

The term “two dimensional display” in all its grammatical forms is used throughout the present specification and claims to mean a display which displays a scene to appear two-dimensional.

In some embodiments, the two displays share a common coordinate system for displaying objects.

In some embodiments an object transferred from one of the displays to the other does not display artifacts when transferred. For example, an object which is transferred from the holographic image to the additional image appears to stay at a same location when transferred, or to move in an expected path and be transferred without a visible disturbance to the path.

An aspect of some embodiments of the invention includes transferring a display of an object or a portion of an object from a first display to a second display.

An aspect of some embodiments of the invention includes displaying movement of an object or a portion of an object from one location in space to another location in space, the displaying of the movement including transferring the display of the object or the portion of the object from a first display to a second display.

The term “holographic display” in all its grammatical forms is used throughout the present specification and claims to mean a display using a fringe pattern to display a holographic image.

The term “holographic image” in all its grammatical forms is used throughout the present specification and claims to mean an image formed by using a fringe pattern. In some embodiments, the holographic image provides a viewer with all depth cues associated with a holographic image formed by using a fringe pattern, including, by way of some non-limiting examples, eye convergence and eye accommodation.

According to an aspect of some embodiments of the present invention there is provided a system with multiple displays, including a first, three-dimensional display, a second display, and a computer for coordinating displaying a scene using the first display to display a first portion of the scene in three dimensions and using the second display to display a second portion of the scene.

According to some embodiments of the invention, the computer is arranged for coordinating the display of the first portion of the scene and the second portion of the scene by using a same coordinate system for displaying the first portion of the scene and for displaying the second portion of the scene.

According to some embodiments of the invention, the computer is arranged for coordinating the display of the first portion of the scene and the second portion of the scene to appear as part of the same scene by using a first coordinate system for displaying the first portion of the scene and a second coordinate system for displaying the second portion of the scene, and the first coordinate system is registered to the second coordinate system.

According to some embodiments of the invention, further including a location detection component for monitoring at least a portion of a volume in space where the first display apparently displays an object and sending location data of an object inserted therein to the computer, wherein the coordinating displaying objects by the first display and the second display is based, at least in part, on the location data of the inserted object sent by the location detection component.

According to some embodiments of the invention, the first, three-dimensional display includes a Head Mounted Display (HMD).

According to some embodiments of the invention, the first, three-dimensional display includes an augmented reality display arranged to display the first portion of the scene and also enable viewing the second portion of the scene.

According to some embodiments of the invention, the location detection component is mechanically coupled to the HMD.

According to some embodiments of the invention, the second display includes a flat screen display. According to some embodiments of the invention, the second display includes a stereoscopic display. According to some embodiments of the invention, the second display includes a touch screen.

According to some embodiments of the invention, the second display is included in the HMD. According to some embodiments of the invention, the computer is included in the HMD.

According to some embodiments of the invention, the computer is external to the HMD and communicates with a computing module included in the HMD.

According to an aspect of some embodiments of the present invention there is provided a user interface for multiple displays, including a computer for coordinating displaying a scene using a first, three dimensional display to display a first portion of the scene in three dimensions and using a second display to display a second portion of the scene, and a location detection component for monitoring at least a portion of a volume in space where the first display displays the first portion of the scene and sending location data of an object inserted into the volume to the computer, wherein the computer coordinates displaying the first portion of the scene and the second portion of the scene based, at least in part, on the location data of the inserted object sent by the location detection component.

According to an aspect of some embodiments of the present invention there is provided a method for using a plurality of displays including using a first three-dimensional display to display a first portion of a scene in three dimensions to appear at a first azimuth, a first elevation and a first distance relative to a viewer's eye, and using a second display to display a second portion of the scene to appear at a second azimuth, a second elevation and a second distance relative to a viewer's eye, using a computer to coordinate displaying the first portion of the scene at a first location and the second portion of the scene at a second location to appear as part of the same scene.

According to some embodiments of the invention, the first three-dimensional display is a CGH image display.

According to some embodiments of the invention, the first three-dimensional display displays the first portion of the scene providing all depth cues, including eye convergence and eye accommodation.

According to some embodiments of the invention, the first portion of the scene overlaps the second portion of the scene in azimuth. According to some embodiments of the invention, the first portion of the scene overlaps the second portion of the scene in elevation.

According to some embodiments of the invention, the first portion of the scene overlaps the second portion of the scene in azimuth and elevation, and the first portion of the scene does not overlap the second portion of the scene in depth.

According to some embodiments of the invention, further including determining which part of the scene belongs to the first portion of the scene and which part of the scene belongs to the second portion of the scene based on user input from a user interface, and the user selecting the first portion of the scene.

According to some embodiments of the invention, further including determining which part of the scene belongs to the first portion of the scene and which part of the scene belongs to the second portion of the scene based on the first distance being less than a specific distance and the second distance being more than the specific distance.

According to some embodiments of the invention, the specific distance is in a range between 0.1 meter and 2 meters.

According to some embodiments of the invention, further including determining which part of the scene belongs to the first portion of the scene and which part of the scene belongs to the second portion of the scene based on the first portion of the scene being a central portion of the scene relative to a direction of view of a viewer and the second portion of the scene being peripheral to the first portion.

According to some embodiments of the invention, at least part of the first portion of the scene overlaps at least part of the second portion of the scene.

According to some embodiments of the invention, the second azimuth is equal to the first azimuth and the second elevation is equal to the first elevation, thereby causing the first portion of the scene to appear at a same direction as the second portion of the scene relative to the viewer, and the first portion of the scene to appear at a different distance as the second portion of the scene relative to the viewer.

According to some embodiments of the invention, further including coloring a third portion of the scene which appears at a same azimuth and a same elevation as a fourth portion of the scene, and at a greater distance than the fourth portion of the scene.

According to some embodiments of the invention, further including using a first color map to display a color of the first portion of the scene and a second color map to display the color of the second portion of the scene.

According to an aspect of some embodiments of the present invention there is provided a method for using a plurality of displays including using a first three-dimensional display to display an image of a first object in three dimensions apparently in a three-dimensional volume in space, detecting a location of a real second object in the three-dimensional volume in space, and transferring displaying the first object from the first display to a second display based, at least in part, on the location of the second object.

According to some embodiments of the invention, the first, three-dimensional display includes a Head Mounted Display (HMD).

According to some embodiments of the invention, the detecting the location of the second object is performed by a location detection component in the HMD.

According to some embodiments of the invention, the second display includes a flat screen display. According to some embodiments of the invention, the second display includes a stereoscopic display.

According to some embodiments of the invention, the second display is included in the HMD.

According to some embodiments of the invention, the transferring displaying the first object from the first display to the second display is performed by a computer included in the HMD.

According to some embodiments of the invention, the transferring displaying the first object from the first display to the second display is performed by a computer external to the HMD which communicates with a computing module included in the HMD.

According to some embodiments of the invention, a decision to transfer displaying the first object from the first display to the second display is performed by a computer external to the HMD which communicates with a computing module included in the HMD.

According to some embodiments of the invention, the second object in the three-dimensional volume in space includes a hand of a viewer viewing the first three-dimensional display inserted into the three-dimensional volume in space.

According to some embodiments of the invention, the second object in the three-dimensional volume in space includes a tool inserted into the three-dimensional volume in space by a viewer viewing the first three-dimensional display.

According to an aspect of some embodiments of the present invention there is provided a method for using a plurality of displays including using a second display to display an image of an object, detecting a location of a user's hand on the second display, and transferring displaying the object from the second display to a first display based, at least in part, on the location.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system.

In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE SEVERAL VIEWS OF THE DRAWING(S)

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a simplified illustration of a user and two displays according to an example embodiment of the invention;

FIG. 2A is a simplified block diagram illustration of a system according to an example embodiment of the invention;

FIG. 2B is a simplified block diagram illustration of a system according to an example embodiment of the invention;

FIG. 3A is a simplified flow chart illustration of a method of using multiple displays according to an example embodiment of the invention;

FIG. 3B is a simplified flow chart illustration of a method of using multiple displays according to an example embodiment of the invention;

FIG. 3C is a simplified flow chart illustration of a method of using multiple displays according to an example embodiment of the invention;

FIG. 3D is a simplified flow chart illustration of a method of using multiple displays according to an example embodiment of the invention;

FIG. 3E is a simplified illustration of selecting which portion(s) of a scene should be displayed by which display, according to an example embodiment of the invention;

FIG. 3F is a simplified illustration of selecting which portion(s) of a scene should be displayed by which display, according to an example embodiment of the invention;

FIG. 4A is a simplified flow chart illustration of a method of using multiple displays according to an example embodiment of the invention;

FIG. 4B is a simplified flow chart illustration of a method of using multiple displays according to an example embodiment of the invention;

FIG. 5 is a simplified flow chart illustration of a method of a user using multiple displays according to an example embodiment of the invention;

FIG. 6 is a simplified flow chart illustration of a method of a user using multiple displays according to an example embodiment of the invention; and

FIG. 7 is a simplified illustration of a system for displaying using multiple displays according to an example embodiment of the invention.

### DESCRIPTION OF SPECIFIC EMBODIMENTS OF THE INVENTION

The present invention, in some embodiments thereof, relates to a system including a holographic display and an additional display and, more particularly, but not exclusively, to a holographic head mounted display and an additional non-holographic display.

An aspect of some embodiments of the invention includes displaying a scene which includes a first portion of the scene using a first, three-dimensional (3D) holographic display, and a second portion of the scene using a second, additional display, and enabling a user to apparently transfer an object in the scene from being displayed by one of the displays to being displayed by the other display.

An aspect of some embodiments of the invention includes displaying a holographic image using a first, three-dimensional (3D) holographic display, and displaying an additional image, either a 3D holographic image or not, using a second, additional display, and enabling a user to apparently transfer an object from one of the displays to the other.

In some embodiments the two displays display images which appear along a same line of sight, or appear in a similar direction and at different depths along the direction. In some embodiments, the transferring an object from one of the display to the other includes a user performing a pushing gesture to transfer an object from a nearer image to a further image, or performing a pulling gesture to transfer an object from a further image to a nearer image.

The terms azimuth, elevation and depth in all their grammatical forms are used throughout the present specification and claims to mean: a horizontal direction (measured as an angle from a specific horizontal direction); a direction measured as an angle from a horizontal plane; and a distance from a user's or viewer's eye, respectively.

In some embodiments, computing images for the two displays shares a common coordinate system for displaying objects.

In some embodiments, an object transferred from one of the displays to the other does not display artifacts when transferred. Artifacts which are prevented from being displayed include, by way of some non-limiting example: a skip or non-linearity in a line of movement of the object when transferred; a skip or non-linearity in a speed movement of the object when transferred; a sudden change in brightness when display is transferred from one display to another; a sudden change in color when display is transferred from one display to another.

For example, an object which is transferred from the holographic image to the additional image appears to stay at a same location when transferred, or to move in an expected path and be transferred without a visible disturbance to the path.

An aspect of some embodiments of the invention includes transferring a display of an object or a portion of an object from a first display to a second display.

An aspect of some embodiments of the invention includes displaying movement of an object or a portion of an object from one location in space to another location in space, the displaying of the movement including transferring the display of the object or the portion of the object from a first display to a second display.

In some embodiments, the first holographic display is a holographic head-mounted display (HMD). In some embodiments, the system optionally includes a location tracker, which optionally monitors at least a volume which includes an apparent location of the object.

In some embodiments, when a user reaches a hand into the volume and apparently touches the object, the holographic HMD optionally interprets the touching as a user interface command referring to the object.

In some embodiments, when a user reaches a stick or a solid object such as a pointer into the volume and apparently touches the object, the holographic HMD optionally interprets the touching as a user interface command referring to the object.

In some embodiments, the first holographic display is a HMD which displays at least one object within hands-reach of a user wearing the HMD.

In some embodiments, based on the user interface command, the object optionally ceases to be displayed by the first, holographic HMD and starts being displayed, at a same apparent location in space, by the second, additional display.

In some embodiments, based on the user interface command, the object optionally continues to be displayed by the first, holographic HMD even after the objects starts being displayed, at a same apparent location in space, by the second, additional display, during a specific duration of time.

In some embodiments, when the object is transferred to be displayed by the second, additional display, the object is displayed differently, by way of some non-limiting examples, using different brightness, and/or hue, and/or shading and/or even size, to indicate the transfer.

In some embodiments, when the object is transferred to be displayed by the second, additional display, the object is displayed similarly, so as not to reveal the transfer, without displaying or at least reducing artifacts of the transfer. By way of some non-limiting examples, reducing or eliminating artifacts such as brightness, and/or hue, and/or shading and/or size, and/or speed of motion and/or linearity of motion.

In some embodiments, the object is optionally displayed as moving from its location in space toward the second display, and at some point in time during or after the moving some or all of the object ceases to be displayed by the first, holographic HMD and starts being displayed, at a same apparent location in space as the object was last displayed by the first display, by the second, additional display.

In some embodiments, the object is optionally displayed as moving from its location in space toward the second display based on the user interface command.

In some embodiments, the object appears to continue to appear moving when displayed by the second display. In some embodiments the transition, from the object being displayed as apparently moving by the first display and the object being displayed as apparently moving by the second display, is apparently smooth, with no sudden non-linearity in location and/or speed of apparent movement.

In some embodiments, the first display is a three dimensional holographic display. In some embodiments, the first display is a three dimensional stereoscopic display. In some embodiments, the first display is a head mounted display.

In some embodiments, the second display is a three dimensional holographic display. In some embodiments, the second display is a three dimensional holographic HMD. In some embodiments, the second display is a three dimensional stereoscopic display. In some embodiments, the second display is a three dimensional auto-stereoscopic display. In some embodiments, the second display is a three dimensional goggle display. In some embodiments, the second display is a three dimensional retinal projection display. In some embodiments, the second display is a different type of three dimensional display as is known in the art.

In some embodiments, the second display is a not-three-dimensional display. In some embodiments, the second display is a flat or curved panel display, optionally such as a computer screen, a TV screen, an LCD monitor, a plasma monitor, and other flat or curved panel displays. In some embodiments, the second display is a curved panel display.

In some embodiments, a space between the first display and the second display is monitored by one or more location detection component(s). Optionally, the component(s) detect a location of an object inserted into the space, and information about the location is transferred to a computer controlling the multiple display system. Optionally the computer tracks movement of the object within the space. Optionally the computer interprets at least some of the movement of the object within the space as an input gesture or gestures.

In some embodiments, the first display is a head-mounted display (HMD), and the location detection component(s) monitor and detect location within space a hand's reach away from the HMD, for example at distances from 0 to 70, 80, 90, 100 and even 120 centimeters from the HMD.

In some embodiments, the location detection component(s) monitor are optionally built into or attached to the HMD, and detect locations within space encompassing a space in which the HMD displays images.

In some embodiments, the location detection component(s) monitor are optionally built into or attached to the HMD, and detect locations within space in a direction in which the HMD displays images.

In some embodiments, the location detection component(s) monitor are optionally built into or attached to the second display, and detect locations within space encompassing a space in a direction from which the second display image(s) are viewable.

An aspect of some embodiments of using the invention includes a user reaching a hand or a tool into a space where a holographic image is displayed using a first, three-dimensional (3D) holographic display. A computer optionally acts as a user interface, detecting the hand or pointer or tool in the space. In some embodiments the computer interprets movements made by the hand/pointer/tool. In some embodiments the computer interprets movements made by the hand/pointer/tool as input gestures.

The term “tool” in all its grammatical forms is used throughout the present specification and claims to mean a tool used for touching, or reaching into a three-dimensional display space, or a tool for interaction with a touch screen, and its corresponding grammatical forms. In some embodiments, the user apparently touches an object in the holographic image, by reaching an apparent location of the object, or by reaching an apparent location of a surface of the object.

In some embodiments, one or more location detection component(s) detect the hand/tool, and provide data about the location of the hand/tool to a computer, which optionally determines whether the hand/tool is at an apparent location of the object.

In some embodiments the user optionally moves his hand/tool, apparently pushing the object in the holographic image toward a second, additional display, and the location determination component detects the pushing gesture, sends data to the computer, which interprets the data and causes the second display to display the object, and optionally also the first, three-dimensional (3D) holographic display to cease displaying the object, enabling a combined display of the first and the second display to apparently transfer an object from the first display to the second.

In some embodiments the apparent pushing is used by the computer to move a location of the object along a path as indicated by a direction of movement of the hand/tool. In some embodiments the apparent pushing is used by the computer to move a location of the object only along a depth direction corresponding to a depth component of the movement of the hand/tool. In some embodiments the user optionally moves his hand/tool, apparently pressing a button or a menu option in the holographic image, and the object displayed in the holographic image is transferred to a second, additional display.

An aspect of some embodiments of the invention includes a user reaching a hand or a tool and touching an object displayed at a location on a display surface, in a second display. In some embodiments, the location of touching the second display is detected by a location determination component as mentioned above. In some embodiments, the location of touching the second display is detected by the display surface of the second display, which may optionally be a touch screen.

The term second display is used herein in order to maintain consistency with the description made above, where the first display is a three-dimensional display, optionally a three-dimensional HMD, optionally a holographic three dimensional HMD, and the second display is an additional display, optionally three-dimensional, optionally not, optionally flat screen, optionally curved screen, optionally some other type of display.

In some embodiments, a computer interprets the touching where an object is located in the second display as selecting the object. In some embodiments, the computer coordinates the object in the second display, having been selected, being displayed by the first display, which in some embodiments is a three-dimensional display, optionally a three dimensional HMD, optionally a three-dimensional holographic HMD. In some embodiments the second display ceases to display the object when the first display starts displaying the object.

In some embodiments, a user optionally selects an object displayed in the second display. The user may select the object by touching an image of the object with his hand or a stylus, by touching the image of the object via touch screen, by selecting via a mouse interface, and by other methods of selection which are known in the art. The user performs a motion of pulling his hand or a stylus away from the second display, and the selected object is displayed to apparently follow the hand or stylus, away from the second display, to appear floating in the air, displayed by the first three-dimensional display, apparently held by or attached to the user's hand. In some embodiments one or more location detection component(s) track the user's hand or stylus, and provided data to one or more a computing module(s) which control the first display and the second display.

In some embodiments, the location detection component(s) optionally track the user's hand, and the computer optionally interprets a movement of the hand being pulled back from the second display screen as a pulling of an object displayed on the second display screen up from the second display screen, to be displayed by the first, three-dimensional display in a space above the screen. In some embodiments, by way of a non-limiting example, when the first display is a HMD, the object is displayed by the first display in a space between the first display and the second display.

In some embodiments the hand/tool is optionally viewed as manipulating an object displayed floating in the air by a three dimensional display and/or on a screen, detects three dimension or two dimensional location of the hand/tool, and implements physics of the manipulating by displaying the object as if actually touched and manipulated by the hand/tool.

An aspect of some embodiments of the invention includes a computer coordinating the first display and the second display so that an object which is apparently transferred from one of the displays to the other does not display artifacts, for example such as described elsewhere herein, when transferred. For example, an object which is transferred from the holographic image to the additional image appears to stay at a same location when transferred, or to move in an expected path and be transferred without a visible disturbance to the path.

In some embodiments, the computer optionally computed locations for displaying objects in a common coordinate system, optionally in the computer's memory.

In some embodiments, a CGH image is combined with a stereoscopic image.

In some embodiments, a CGH image is combined with a 2D image.

In some embodiments, different images are displayed, at same spatial coordinates but at different vergence and eye accommodations, causing the different images to appear to be at different distances from a viewer, potentially even when displayed by one display.

In some embodiments, a display of an image is changed from displaying a CGH image to displaying a stereoscopic image at a same apparent location, and vice versa.

In some embodiments, data values for displaying a CGH image are changed to data values for displaying a 2D image or a stereoscopic image and vice versa.

An aspect of the invention relates to interaction of a viewer in a volume of space which apparently contains a CGH image displayed by a three-dimensional display, optionally affecting or changing a portion of a scene displayed by a two-dimensional display.

An aspect of the invention relates to interaction of a viewer with a 2D image, by way of a non-limiting example by using a touch screen, optionally affecting or changing a display of a CGH image.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

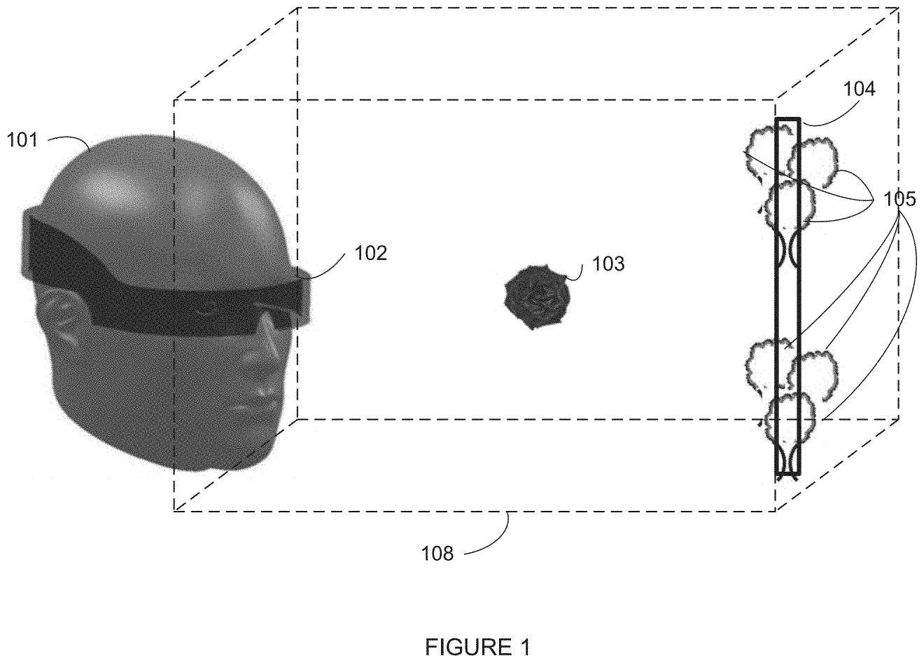

Reference is now made to FIG. 1, which is a simplified illustration of a user and two displays according to an example embodiment of the invention.

FIG. 1 shows a user 101 wearing a first three-dimensional holographic head mounted display (HMD) 102, who sees a first image 103, by way of a non-limiting example a rose, and also, through the HMD 102, a second image 105, by way of a non-limiting example trees displayed by a flat screen second display 104.

FIG. 1 shows a relatively narrow interpretation of an example embodiment, in that, at least:

In some embodiments the first display 102 does not necessarily have to be a holographic display, and does not necessarily have to be a head mounted display (HMD). The first display may be a head mounted display which apparently displays in three dimensions without displaying a holographic image, such as, by way of a non-limiting example, a stereoscopic display, or a display which displays in apparent 3D using perspective. The first display 102 may be a 3D display which optionally displays a 2D image floating in the air, working in conjunction with the second display 104;

the second display 104 does not necessarily have to be a flat screen display, and may optionally be an additional display, whether holographic, stereoscopic or non-three-dimensional, displaying to the user 101 in a manner such that the user 101 can see both an image displayed by the first display 102 and an image displayed by the second display 104;

the second display 104 does not necessarily have to be a flat screen display, and may optionally be an additional display, whether holographic, stereoscopic or non-three-dimensional, built into the HMD; and

the rose and the trees are just example of possible objects displayed by the first display 102 and the second display 104.

A location determination component (not shown) optionally monitors objects in a volume 108 where the first display 102 displays an apparent location of the image 103 of the rose.

If and when the user 101 reaches his hand (not shown) into the volume 108, the location determination component detects a location of the user's hand, and optionally sends data related to the location to a computer (not shown).

If and when the user 101 makes a movement of pushing the image 103 of the rose toward the second display 104, the location determination component optionally detects locations of the user's hand and/or tracks movement of the user's hand, and optionally sends data related to the locations or the movement to the computer.

In some embodiments the computer coordinates display of the image 103 of the rose so that the first display 102 optionally displays the image 103 of the rose moving toward the second display 104, and at a certain point in time, when the image 103 of the rose is at a certain point in space, the second display 104 starts displaying the image 103 of the rose, and optionally the first display 102 stopes displaying the image 103 of the rose.

In some embodiments, the volume 108 extends at least all the way from the first display 102 to the second display 104.

In some embodiments, the volume 108 extends from a specific distance in front of the first display 102 all the way to the second display 104. In some embodiments the specific distance is a distance at which a viewer can be expected to be able to focus the image 103. By way of a non-limiting example, the specific distance is optionally 15 centimeters.

In some embodiments, the volume 108 extends from a first specific distance in front of the first display 102 to a second specific distance toward the second display 104. In some embodiments the second specific distance is a user's hand reach distance. By way of a non-limiting example, the second specific distance is optionally 10, 20, 30, 40, 50, 60, 70, 80, 90, 100, 110 or 120 centimeters.

In some embodiments, the first display 102 optionally displays the rose 103 to appear at a location behind the second display 104.

In some embodiments, the first display 102 optionally displays the rose 103 to appear at a same distance from the user 101 as the second display 104.

In some embodiments the second image 105 is not an image of trees, but a second image 105 of a cross section of the first image 103.

In some embodiments the second image 105 is not an image of trees, but a second image 105 of a two-dimensional representation of the first image 103.

In some embodiments the image 105 of a cross section of the first image 103 is of a cross section at a plane perpendicular to a direction of a viewer's view.

In some embodiments the image 105 of a cross section of the first image 103 is optionally defined as a cross section at a specific depth within the first image 103.

In some embodiments the specific depth is optionally determined by a computer control (not shown) displayed by the first display 102 and/or the second display 103, optionally by the user 101 providing input to the computer control.

In some embodiments the specific depth is optionally determined by a frame (not shown) held by the user 101 at the specific depth within the first image 103.

In some embodiments a plane of the cross section corresponds to a plane of the frame.

In some embodiments the image 105 of a cross section of the first image 103 is optionally defined as a cross section at a specific plane determined by a hand/tool motion passing through the first image 103, apparently slicing through an object in the image 103.

In some embodiments the first image 103 is displayed to appear as a three-dimensional image 103 having depth, the depth extending from in front of the second display 104 to behind the second display 104, and the image 105 of the cross section of the first image 103 is a cross section of the first image 103 at the plane of the second display 104.

In some embodiments the first image 103 is displayed to appear as a three-dimensional holographic image 103 having all depth cues of a real object, including, by way of some non-limiting examples, eye convergence and eye accommodation.

In some embodiments the second display 104 is optionally used to display an image which is at least partly associated with the image 103 displayed by the first display 102. By way of some non-limiting example, the image 105 displayed by the second display 104 may include:

not displaying a portion of the image 105 which is behind the location in space where the image 103 appears to be. The portion of the image 105 not displayed is optionally of a shape corresponding to an outer circumference of an object in the image 103;

displaying a shaded area in the image 105 which corresponds to an area of a shadow which would be cast by an object in the image 103 of the first display 102. The shadow may optionally correspond to a shadow cast by a specific direction of illumination relative to the object in the image 103, or to a specific direction of illumination relative to the user 101;

displaying control items such as, by way of some non-limiting examples, displaying a menu and/or a button control and/or a slider control which are associated with the image 103 displayed by the first display 102 in that activating the controls displayed by the second display 104 affects the display of the image 103 displayed by the first display 102.

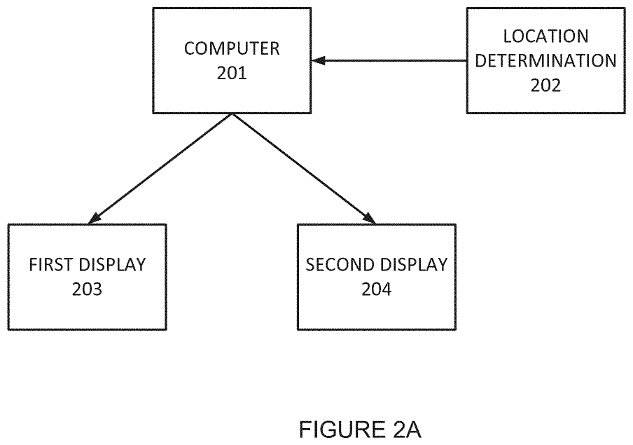

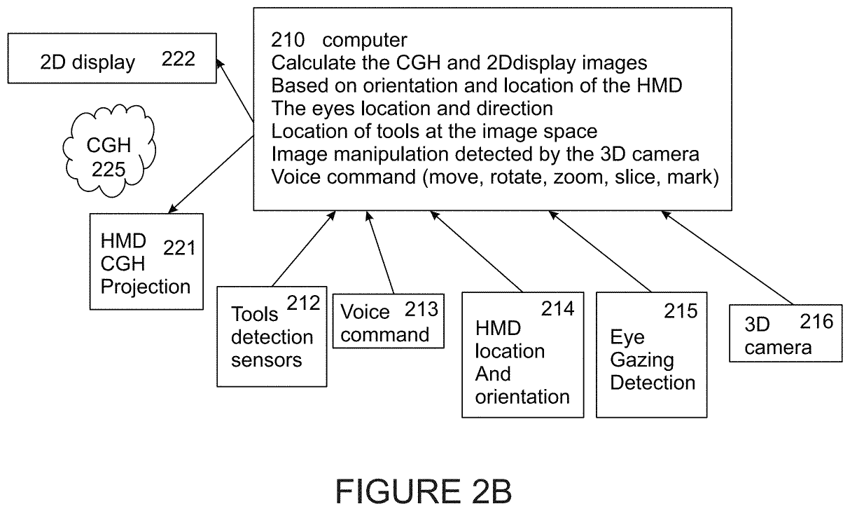

Reference is now made to FIG. 2A, which is a simplified block diagram illustration of a system according to an example embodiment of the invention.

FIG. 2A shows a first display 203 and a second display 204; a computer 201 connected to the first display 203 and the second display 204; and a location determination component 202 connected to the computer 201.

In some embodiments, the location determination component 202 comprises a component such as, by way of some non-limiting example, a laser rangefinder, a sound wave based range finder, a focus based rangefinder, and a camera.

In some embodiments, the location determination component 202 is mechanically attached to the first display 203.

In some embodiments, the location determination component 202 is mechanically attached to the second display 204.

In some embodiments, not one location determination component 202 is used, but more than one. By way of a non-limiting example, two cameras may be used, optionally measuring distance to an object by triangulation.

In some embodiments, one or more location determination components 202 are also used to detect location and/or viewing direction or axis of the first display 203 relative to location and/or viewing direction or axis of the second display 204.

In some embodiments the computer 201 is more than one computer. In some embodiments the computing is distributed between more than one computing units. In some embodiments one or more of the computing units may be integrated into the first display 203; into a HMD; into the second display 204; into the location determination component 202; and/or into some separate computing enclosure or even be in the cloud.

In some embodiments a first instance of a computer 201 is mechanically attached to the first display 203, and a second instance of the computer 201 is mechanically attached to the second display 204.

In some embodiments data describing an object or a portion of a scene displayed by the first display 203 is computed by a first instance of the computer 201 which is mechanically attached to the first display 203.

In some embodiments data describing an object or a portion of a scene displayed by the second display 204 is computed by a second instance of the computer 201 which is mechanically attached to the second display 204.

In some embodiments, when displaying an object or a portion of a scene is transferred from the first display 203 to the second display 204, the data for displaying the object or the portion of the scene is transferred from the first instance of the computer 201 to the second instance of the computer 201.

In some embodiments the computer 201 optionally computes values for the first display 203 for displaying a first portion of a scene.

In some embodiments the computer 201 optionally computes values for the second display 204 for displaying a second portion of the scene.

In some embodiments the computer 201 optionally computes values for the first display 203 for displaying a first portion of a scene and values for the second display 204 for displaying a second portion of the scene using a same coordinate system for the computing.

In some embodiments the computer 201 optionally uses location determination data for determining a distance and direction from the first display 203 to the second display 204, for computing the values for the first display 203 for displaying the first portion of the scene and values for the second display 204 for displaying the second portion of the scene using a same coordinate system for the computing.

In some embodiments the computer 201 is mechanically attached to the first display 203.

In some embodiments the computer 201 is mechanically attached to the second display 204.

In some embodiments the first display 203, optionally a CGH, includes a location determination unit 202 which measures a location of the second display 204.

In some embodiments the location determination unit 202 measures the location of the second display 204 based on image processing an image of specific markings placed or drawn on the second display 204 optionally computing based on an angular extent of the location of the specific markings on the second display 204 in the image of the second display 204.

In some embodiments the location determination unit 202 measures the location of the second display 204 based on image processing an image of the second display 204, optionally detecting edges of the second display 204, optionally computing based on an angular extent of the second display in the image of the second display 204.

In some embodiments: the second display 204 is optionally located in front of a location of an image displayed by the first display 203, with respect to a viewer viewing the image displayed by the first display 203; the second display 204 is optionally located behind a location of an image displayed by the first display 203, with respect to a viewer viewing the image displayed by the first display 203; or the second display 204 is optionally located at a same distance as a location of an image displayed by the first display 203, with respect to a viewer viewing the image displayed by the first display 203.

Reference is now made to FIG. 2B, which is a simplified block diagram illustration of a system according to an example embodiment of the invention.

FIG. 2B shows a computer 210, connected to:

Inputs from one or more optional components such as: tool detection sensor(s) 212; voice command detection and/or interpretation component(s) 213; HMD location and/or orientation detection component(s) 214; eye gaze direction detection component(s) 215; and a 3D camera 216;

and

Outputs to: a HMD CGH image display 221; and a 2D display 222.

In some embodiments, computer 210 uses data input by one or more of the input sources, and data describing a 3D scene, to decide which portions of the 3D scene will be displayed by which of the displays 221 222, optionally to calculate appropriate values describing respective portions of the 3D scene, and provides output of the appropriate values to the HMD CGH image display 221 and the 2D display 222, to display a scene which includes a CGH image 225.

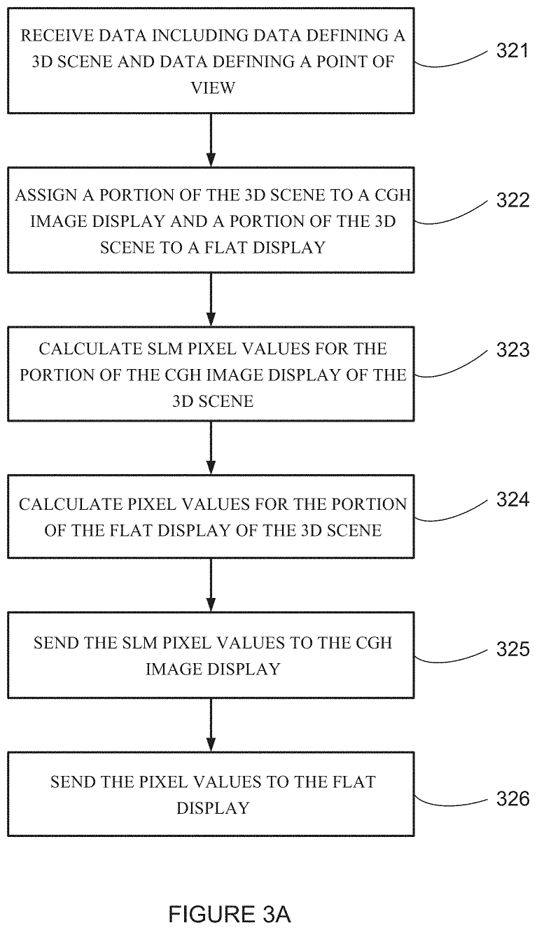

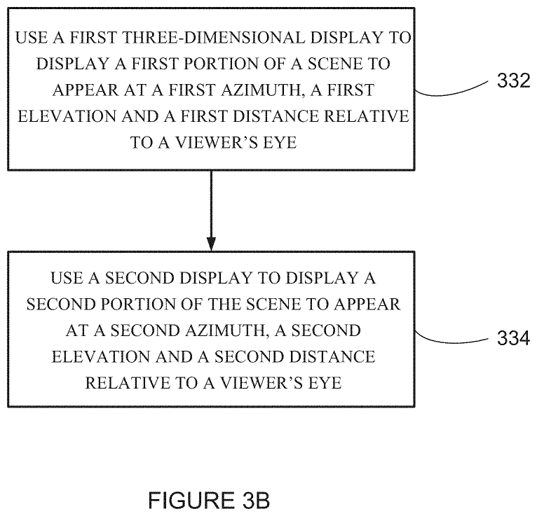

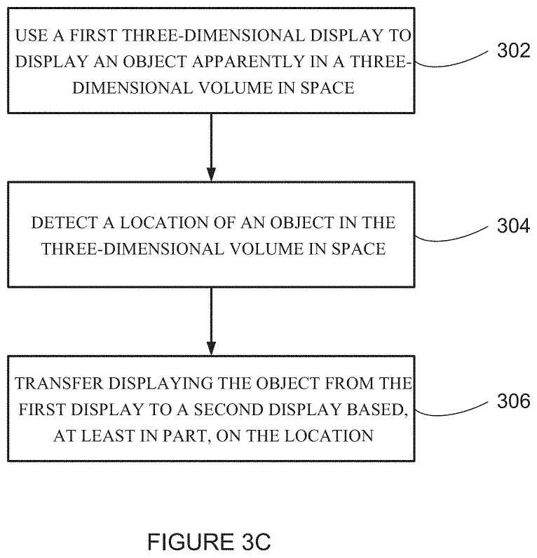

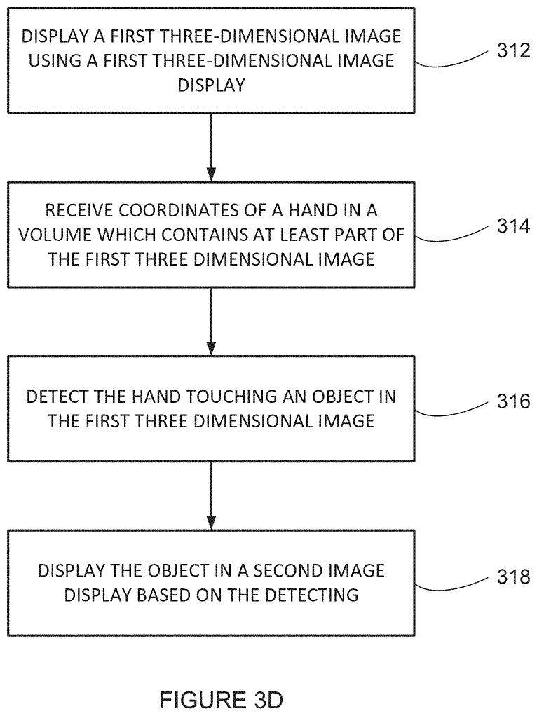

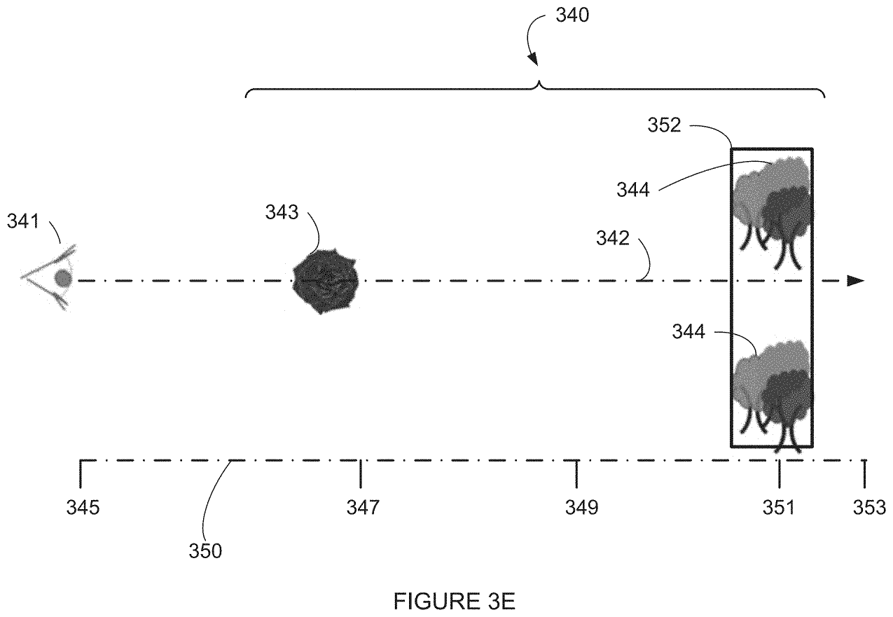

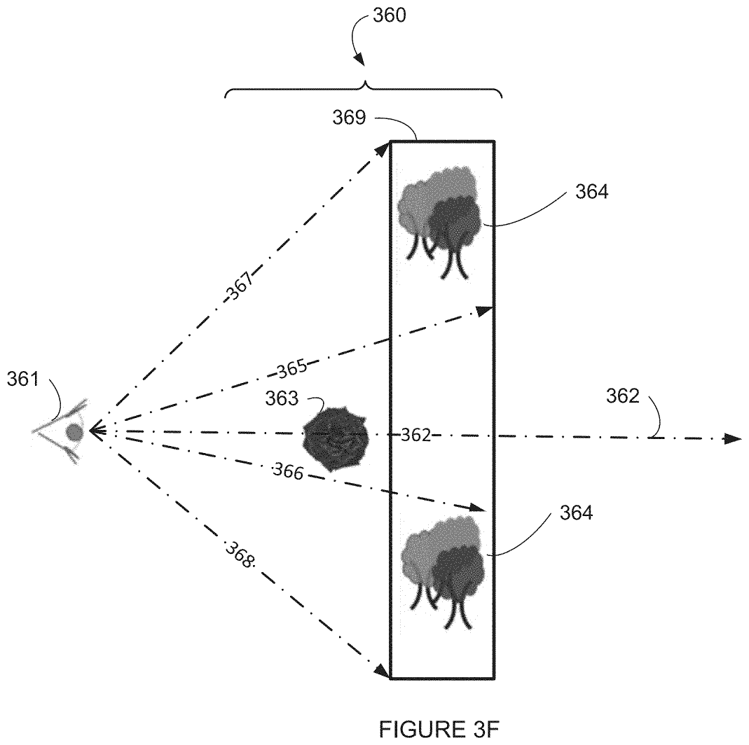

Reference is now made to FIG. 3A, which is a simplified flow chart illustration of a method of using multiple displays according to an example embodiment of the invention.

FIG. 3A describes an example embodiment of a computer receiving data for producing an image of a scene, and distributing displaying the scene between multiple displays according to an example embodiment of the invention.

The method of FIG. 3A includes:

receiving data including data defining a 3D scene and data defining a point of view (321);

assigning a portion of the 3D scene to a CGH image display and a portion of the 3D scene to a flat display (322);

calculating SLM pixel values for the portion of the CGH image display of the 3D scene (323);

calculating pixel values for the portion of the flat display of the 3D scene (324);

sending the SLM pixel values to the CGH image display (325); and

sending the pixel values to the flat display (326).

In some embodiments the receiving data optionally includes a location in 3D scene that is at a center of a field of view of a viewer. In some embodiments the receiving data optionally includes a direction of a gaze of a viewer.

In some embodiments the flat display is a two-dimensional (2D) display used for displaying stereoscopic images.

In some embodiments the assigning the portion of the 3D scene to a CGH image display and the portion of the 3D scene to a flat display is optionally performed by assigning a near-by portion of the 3D scene, by way of a non-limiting example a portion of the 3D scene to be displayed at an apparent distance from a viewer's eye smaller than some specific distance, to be displayed by the CGH image display. In some embodiments, the specific distance is optionally in a range between 1 meter and 2 meters, for example 1.5 meters. In some embodiments the specific distance is based upon a specific distance beyond which a viewer is not able to perform focus accommodation, and/or beyond which a viewer is not sensitive to inconsistencies in eye focus accommodation.

In some embodiments the assigning the portion of the 3D scene to a CGH image display and the portion of the 3D scene to a flat display is optionally performed by assigning a central portion of the 3D scene, by way of a non-limiting example a portion of the 3D scene to be displayed inside a field of view of a viewer's fovea, to be displayed by the CGH image display, and other portion(s) to the flat display. In some embodiments the portion assigned to the CGH display includes a field of view larger than the fovea field of view by a specific angle margin.

In some embodiments the portion assigned to the CGH display includes a field of view based on tracking the viewer's pupil.

In some embodiments, a portion of the 3D scene not assigned to the CGH image display is assigned to the flat display.

In some embodiments, the flat display is a stereoscopic image display, and a portion of the 3D scene assigned to be displayed by the stereoscopic image display is calculated and provides different values for display to a left eye and a right eye of a viewer.

In some embodiments, the flat display is a non-stereoscopic image display.

A user interface scenario according to an example embodiment of the invention is now described:

a user views a medical scene, in which are displayed a heart and beyond the heart some additional organs/blood vessels/bones/skin;

the user inserts his/her hand into a volume of space where the medical scene is apparently displayed;

a 3D location capturing system, such as, by way of some non-limiting examples, a Leap system or an Intel 3D camera, captures coordinates of a location of the hand at proximity to a CGH image of the heart, optionally capturing coordinates of two or three locations, of two or three fingers;

the 3D location capturing system optionally sense the hand moving in a ‘rotation’ mode, for example by detecting an angular translation of the fingers, and/or a ‘move’ mode, for example by detecting a lateral translation of the fingers, and/or a ‘zoom’ mode, for example by detecting an increasing or decreasing distance between the fingers;

a computer calculates which of data of the 3D scene is part of a new rotated or translated or re-sized image;

the computer calculates which portion(s) of the 3D scene are to be displayed as a CGH image, the heart in this example, and which portion(s) of the 3D scene are to be displayed as 2D data, the remote organs in this example;

a new CGH image is calculated;

a new 2D stereoscopic image is calculated;

the new CGH image is displayed by a CGH image display; and

the new 2D stereoscopic image is displayed by a stereoscopic images display.

A user interface scenario of an example embodiment being used in a Computer Aided Design (CAD) environment is now described:

a scene of a motor including various motor parts is displayed by a 2D display;

an engineer reaches his/her hand and touches a motor part in the 2D display. The 2D display may be a touch screen which provides a location of a touch, or optionally a 3D location capturing system such as a camera may detect a specific location of a displayed motor part being touched;

the engineer's hand makes a motion of pulling the motor part closer to the engineer's eye;

the 3D location capturing system detects the hand moving and an 3D CGH image of the motor part is displayed at a location of the hand, as if the hand is actually holding the motor part;

a 2D portion of the scene is re calculated and displayed, to exclude the motor part which is now displayed as a CGH image.

In some embodiments various objects in the image space, such as tools or solid objects, are detected and used to provide input to a user interface.

In some embodiments, a change of viewing orientation changes both a CGH image and a 2D image. Such changes optionally include projecting new parts of an image, shading parts of the 2D image that appear behind the CGH image, and un-shading parts that appear from behind the CGH image due to the change of viewing orientation.

In some embodiments image color is optionally used as a depth map, with a CGH image, and optionally closer objects displayed by a 2D display are displayed using one set of colors, and more remote objects are optionally displayed using a second set of colors.

Reference is now made to FIG. 3B, which is a simplified flow chart illustration of a method of using multiple displays according to an example embodiment of the invention.

FIG. 3B describes an example embodiment of a method for using a plurality of displays.

The method of FIG. 3B includes:

using a first three-dimensional display to display a first portion of a scene to appear at a first azimuth, a first elevation and a first distance relative to a viewer's eye (332); and using a second display to display a second portion of the scene to appear at a second azimuth, a second elevation and a second distance relative to a viewer's eye (334).

In some embodiments, it is a CGH image display used to display the first portion of the scene and some second display to display the second portion of the scene. The second display may be another CGH display, a stereoscopic display, a flat panel display, as well as other displays as are known in the art.

In some embodiments, determining which part of the scene belongs to the first portion of the scene and which part of the scene belongs to the second portion of the scene is done so that the first distance is less than a specific distance and the second distance is more than the specific distance. In some embodiments the specific distance is in a range between 0.1 meter and 2 meters.

In some embodiments determining which part of the scene belongs to the first portion of the scene and which part of the scene belongs to the second portion of the scene is performed so that the first portion of the scene is a central portion of the scene, relative to a direction of view of a viewer, and the second portion of the scene is peripheral to the first portion.

In some embodiments at least part of the first portion of the scene overlaps at least part of the second portion of the scene.

In some embodiments the second azimuth is equal to the first azimuth and the second elevation is equal to the first elevation, causing the first portion of the scene to appear at a same direction as the second portion of the scene relative to the viewer, and the first portion of the scene to appear at a different distance as the second portion of the scene relative to the viewer.

In some embodiments a third portion of the scene, which appears at a same azimuth and a same elevation as a fourth portion of the scene, and at a greater distance than the fourth portion of the scene, is shaded and/or colored a darker color than it would otherwise be colored, and/or colored black.

In some embodiments a first color map is used to display the first portion of the scene and a second color map is used to display the second portion of the scene.

Reference is now made to FIG. 3C, which is a simplified flow chart illustration of a method of using multiple displays according to an example embodiment of the invention.

FIG. 3C illustrates a method for a computer to coordinate displaying an object using multiple displays.

The method of FIG. 3C includes:

using a first three-dimensional display to display an object apparently in a three-dimensional volume in space (302);

detecting a location of an object in the three-dimensional volume in space (304); and

transferring displaying the object from the first display to a second display based, at least in part, on the location (306).

Reference is now made to FIG. 3D, which is a simplified flow chart illustration of a method of using multiple displays according to an example embodiment of the invention.

FIG. 3D illustrates a method for a computer to coordinate displaying an object using multiple displays.

The method of FIG. 3D includes:

displaying a first three-dimensional image using a first three-dimensional image display (312);

receiving coordinates of a hand in a volume which contains at least part of the first three-dimensional image (314);

detecting the hand touching an object in the first three-dimensional image (316); and

displaying the object in a second image display (318) based, at least in part, on the detecting.

Reference is now made to FIG. 3E, which is a simplified illustration of selecting which portion(s) of a scene should be displayed by which display, according to an example embodiment of the invention.

FIG. 3E shows an example scene 340 which includes a first object 343, in this case a rose, for displaying at an apparent distance closer to a viewer's eye(s) 341, and additional object(s) 344, in this case trees, for displaying at an apparent greater distance from the viewer's eye 341.

FIG. 3E also shows a qualitative distance scale 350, with hash marks 345 347 349 351 353, the hash marks showing distances along an optic axis 342 from the viewer's eye 341. A first has mark 345 indicates zero distance from the viewer's eye 341. The hash mark distances in FIG. 3E are qualitative, and distances are not drawn to scale.

In some embodiments, the rose 343 is at a distance corresponding to a second hash mark 347, and optionally displayed using a first display (not shown), optionally a three-dimensional (3D) display, optionally a HMD, optionally a holographic display, optionally a 3D holographic HMD.

In some embodiments, portions of a scene which are beyond some specific distance are optionally selected to be displayed by one or more additional display(s) 352, other than the first display.

By way of a non-limiting example, the specific distance may correspond to the second hash mark 347, and any portion of the scene which is to be displayed at an apparent distance greater than that of the location of the second hash mark 347 is optionally displayed by the one or more additional display(s) 352.

By way of a non-limiting example, the specific distance may correspond to a third hash mark 349, somewhere beyond the rose 343, yet closer than an actual location of the additional display(s) 352 which corresponds to a fourth hash mark 351, and any portion of the scene which is to be displayed at an apparent distance greater than that of the location of the third hash mark 349 is optionally displayed by the one or more additional displays. In some embodiments the additional display(s) 352 may be a 3D display(s), optionally a stereoscopic display(s) or a holographic display(s) or some other type of apparently 3D display, and display their portion of the scene as having a distance which appears to be closer than the fourth hash mark 351 and further than the third hash mark 349.

By way of a non-limiting example, the specific distance may correspond to a fourth hash mark 349, and a portion of the scene which is to be displayed anywhere between the viewer's eye 341 and the additional display(s) 352 at the fourth hash mark 351 is optionally displayed by the first display, while a portion of the scene which is to be displayed further than the fourth hash mark 351 is optionally displayed by the one or more additional display(s) 352.

By way of a non-limiting example, the specific distance may correspond to a fifth hash mark 353, somewhere beyond a location of the additional display(s) 352. A portion of the scene which is to be displayed at an apparent distance greater than that of the location of the fifth hash mark 349 is optionally displayed by the one or more additional displays. By way of a non-limiting example the additional display(s) may be 3D display(s), optionally stereoscopic display(s) or holographic displays or some other type of apparently 3D display, and display their portion of the scene as having a distance which appears to be further than the fourth hash mark 351 and/or also closer than a location of the fourth hash mark 351.

Reference is now made to FIG. 3F, which is a simplified illustration of selecting which portion(s) of a scene should be displayed by which display, according to an example embodiment of the invention.

FIG. 3F shows an example scene 360 which includes a first object 363, in this case a rose, for displaying at a central portion of a field of view of a viewer's eye(s) 361, and additional object(s) 364, in this case trees, for displaying at a more peripheral portion of the field of view of the viewer's eye(s) 362.

FIG. 3F shows the central portion of the field of view of a viewer's eye(s) 361 extending from an optical axis 362 directly in a center of the viewer's field of view on one side up to a first direction 365 somewhat away from the optical axis 362, and on another side up to a second direction 366. FIG. 3F also shows the more peripheral portion of the field of view of a viewer's eye(s) 361 extending from the first direction 365 and away from the optical axis 362 up to a third direction 367, and on another side from the second direction 366 and away from the optical axis 362 up to a fourth direction 368.

FIG. 3F shows a qualitative drawing of the directions of the optic axis 362, directions 365 366 which are limits of the central portion of the field of view, and directions 367 368 which are limits of the more-peripheral portion of the field of view. The directions drawn in FIG. 3F are qualitative, and are not drawn to scale.

In some embodiments the central portion of the field of view includes: less than a human foveal field of view; exactly the human foveal field of view; and more than the human foveal field of view. A human foveal field of view is approximately 20 degrees across. In the present specification and claims the term foveal field of view in all its grammatical forms refers to approximately 20 degrees.

In some embodiments the central portion of the field of view includes a span of 2, 5, 10, 20, 30, 40, 50, 60, 70, 80, 90, 100, 110, 120, 130, 140, 150, 160, 170, 180, 190, 200 and up to 300 degrees.

It is noted that the use of the terms “central field of view” and “more peripheral field of view” applies, in some embodiments, to horizontally-central and horizontally-peripheral, in some embodiments, to vertically-central and vertically-peripheral, and in some embodiments to applying to any direction different from the optical axis 362.

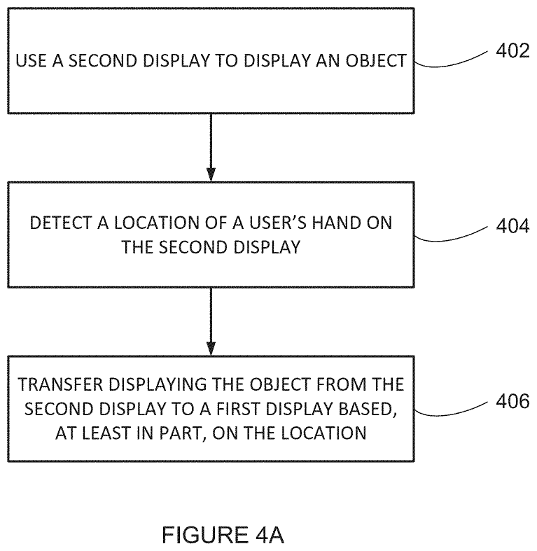

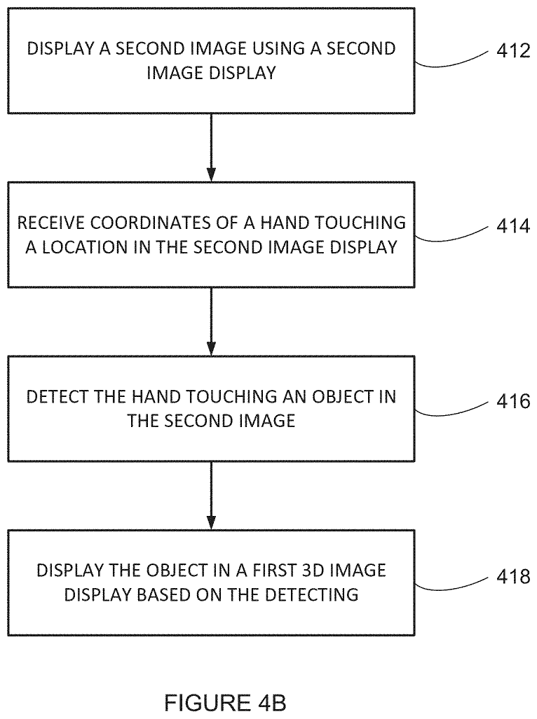

Reference is now made to FIG. 4A, which is a simplified flow chart illustration of a method of using multiple displays according to an example embodiment of the invention.

FIG. 4A illustrates another method for a computer to coordinate displaying an object using multiple displays.

The method of FIG. 4A includes:

using a second display to display an object (402);

detecting a location of a user's hand on the second display (404); and

transferring displaying the object from the second display to a first display based, at least in part, on the location (404).

In some embodiments, the location on the second display 404 is a location of a tool, for example of a stylus or light pen. In some embodiments, the location on the second display 404 is a location of user-interface pointer, such as a pointer controlled by a mouse.

Reference is now made to FIG. 4B, which is a simplified flow chart illustration of a method of using multiple displays according to an example embodiment of the invention.

FIG. 4B illustrates another method for a computer to coordinate displaying an object using multiple displays.

The method of FIG. 4B includes:

displaying a second image using a second image display (412);

receiving coordinates of a hand touching a location in the second image display (414);

detecting the hand touching an object in the second image (416); and

displaying the object in a first three-dimensional image display (418) based, at least in part, on the detecting.

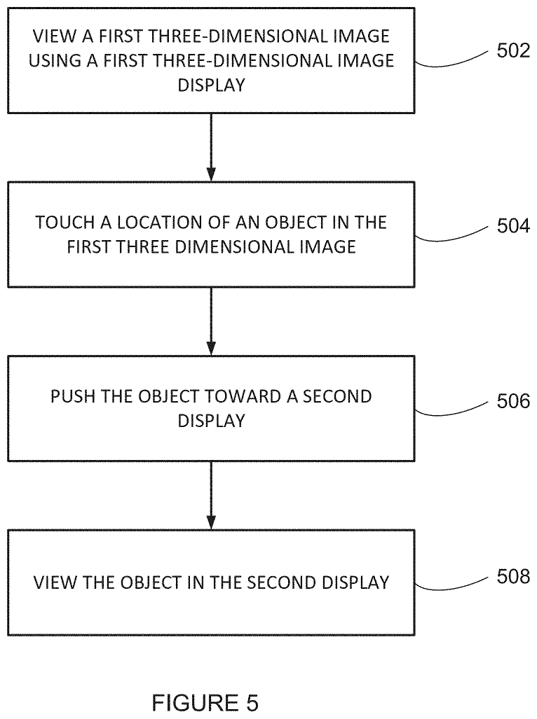

Reference is now made to FIG. 5, which is a simplified flow chart illustration of a method of a user using multiple displays according to an example embodiment of the invention.

FIG. 5 illustrates a method for a user to transfer displaying an object from a first three-dimensional display to a second display.

In some embodiments the object displayed in the first display appears to the user to float in the air in the user's field of view.

In some embodiments the first display is a three dimensional holographic display. In some embodiments the first display is a three dimensional stereoscopic display. In some embodiments the first display is a head mounted display.

In some embodiments the second display is also a three dimensional display. In some embodiments the second display is a three dimensional stereoscopic display. In some embodiments the second display is a three dimensional holographic display.

In some embodiments the second display is not a three dimensional display. In some embodiments the second display is a flat panel display.

The method of FIG. 5 includes:

viewing an object in a first three-dimensional image using a first three-dimensional image display (502);

touching a location of the object in the first three-dimensional image (504);

pushing the object toward a second display (506); and

viewing the object in the second image display (508).

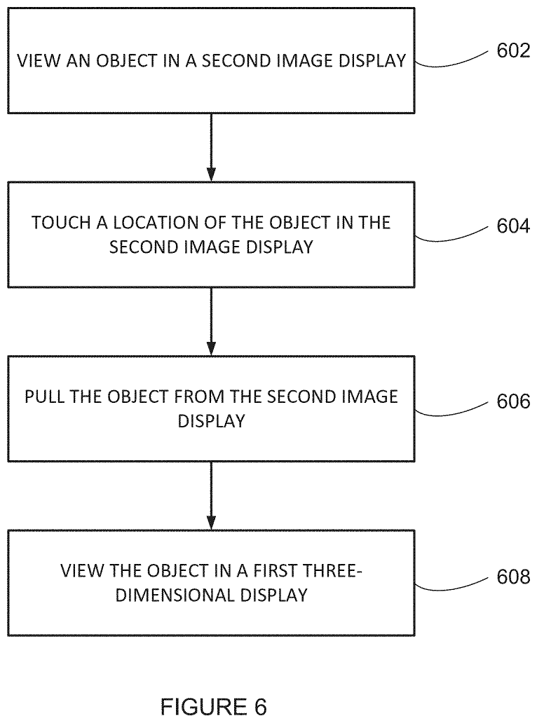

Reference is now made to FIG. 6, which is a simplified flow chart illustration of a method of a user using multiple displays according to an example embodiment of the invention.

FIG. 6 illustrates a method for a user to transfer displaying an object from a second display to a first three-dimensional display.

Optional embodiments described above with reference to FIG. 5 also hold for FIG. 6, with the terms first display and second display optionally maintaining the same meaning.

The method of FIG. 6 includes:

viewing an object in a second image using a second image display (602);

touching a location of the object in the second image display (604);

pulling the object from the second image display (606); and

viewing the object in a first, three-dimensional image display (608).

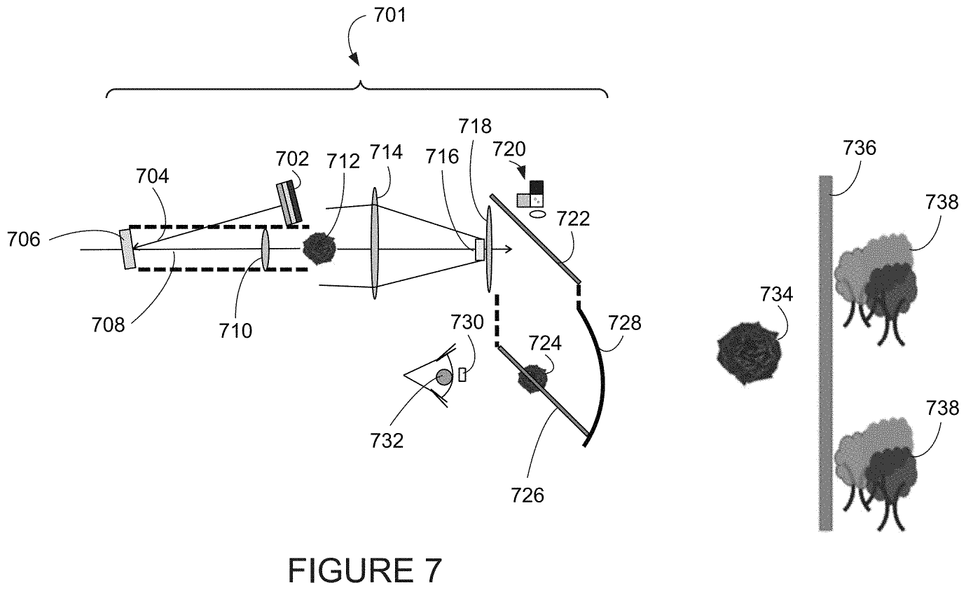

Reference is now made to FIG. 7, which is a simplified illustration of a system for displaying using multiple displays according to an example embodiment of the invention.

FIG. 7 is a detailed illustration of a system for viewing three dimensional images using a first augmented reality holographic head mounted display (HMD), and second flat panel display.

FIG. 7 shows HMD components for displaying a holographic image to one eye. In some embodiments the HMD components are repeated for displaying a holographic image to a second eye. In some embodiments a field of view of the HMD includes two eyes simultaneously. In some embodiments a field of view of the HMD is alternately cast to one eye and to a second eye.

Additional embodiments for components for viewing three dimensional images using a first augmented reality holographic head mounted display (HMD) are described in above-mentioned PCT patent application number IL2017/050226 of Gelman et al.

FIG. 7 includes optional components which serve to improve a viewing of a three dimensional image.

Components included in the example embodiment of an HMD 701 shown by FIG. 7 include: one or more coherent light source(s) 702, optionally three light sources in Red, Green and Blue; a Spatial Light Monitor (SLM) 706; an optional first optical element 710; an optional second optical element 714; an optional focusing lens 718; a first mirror 722; a second mirror 726; and a screen 728.

In some embodiments, the screen 728 is reflective at the one or more wavelength of the coherent light, e.g. at Red, Green and Blue wavelengths, and transparent at other wavelengths. A non-limiting example of such a screen is a transparent optical element coated with tri-chroic coatings tuned to the Red, Green and Blue wavelengths.

A description of a path of light through the example embodiment of an HMD 701 shown by FIG. 7 is now provided.

Coherent light 704 is projected from the coherent light source(s) 702 toward the SLM 706. The SLM 706, which is optionally a reflective SLM, modulates the coherent light 704, and reflects modulated light 708. The modulated light 708 optionally passes through the optional first optical element 710, optionally forming a first holographic image 712. In FIG. 7 the holographic image is shown, by way of a non-limiting example, as an image of a rose. The modulated light 708 continues on, through the optional second optical elements 714, and onto the focusing lens 718. The modulated light 708 is reflected from the first mirror 722, and forms a second holographic image 724, optionally approximately at the second mirror 726.

A viewer looking toward the screen 728, sees a reflection of the second holographic image 724, which is composed of the coherent light source(s) wavelengths. The screen 728 is designed to reflect at those wavelengths, while passing through light at other wavelengths, so the viewer sees both a reflection of the second holographic image 724, and a view of whatever may be seen through the screen 728.

In some embodiments, an additional display, by way of a non-limiting example an additional display 736, is seen through the screen 728. By way of a non-limiting example, FIG. 7 shows the additional display 736 displaying images of trees, apparently approximately at a same distance or depth from the viewer as the additional display 736.

In some embodiments the second mirror 726 is optionally a mirror adjustable in angle, so as to direct the second holographic image 724 to a viewing pupil 732, and to direct an image 730 of the SLM 706 to the viewing pupil 732.

In some embodiments the second mirror 726 is optionally partly reflective and partly transmissive, so the viewing pupil can view the screen 728 and/or the additional display 736 and/or the real world through the second mirror 726.

In some embodiments the additional display 736 is a flat screen display.

In some embodiments the additional display 736 is a display for displaying stereoscopic images, which may optionally be used to display image depth using stereoscopic methods. In some embodiments, where the additional display 736 is a stereoscopic display which uses polarization, the screen 728 is optionally produced with polarization matching the polarization of the additional display 736.

In some embodiments the screen 728 is curved, acting as a magnifier for a viewer viewing through the viewing pupil 732. So the viewer sees the second holographic image 724 at a different size, e.g. magnified, and/or at a different distance from the viewing pupil 732 than the second holographic image 724. In some embodiments the viewer sees the second holographic image 724 apparently floating in the air at a location 734, in some embodiments floating in the air within arm's reach of the viewer, optionally between the viewer and the additional display 736.

In some embodiments, one or more components (not shown) for locating a location of object in a volume of space between the HMD 701 and the additional display 736 provide data, such as location and spatial coordinates, about objects in the volume of space between the HMD 701 and the additional display 736.

In some embodiments, the object locating components are optionally built into the HMD 701. In some embodiments, the object locating components are optionally separate from the HMD 701.

In some embodiments, a computer which computes values for the SLM in order to display a specific image apparently at a specific location 734 in space, optionally receives coordinates of an object, such as a hand and/or a pointer (not shown), in the volume which is monitored, and which optionally contains at least part of the apparent location 734 of the second holographic image 724.

In some embodiments, a computer which computes values for the SLM in order to display a specific image apparently at a specific location 734 in space, optionally receives coordinates of an object, such as a hand and/or a pointer (not shown), touching the additional display 736.

In such embodiments, the coordinates are optionally used to implement methods such as, by way of some non-limiting examples, described above with reference to FIGS. 3A-3D, 4A-4B, 5 and 6.

Reference numbers 712 and 724 show, qualitatively, where holographic images are in focus, in the example embodiment of FIG. 7. Reference number 734 shows, qualitatively, where the second holographic image 724 appears to be, to a viewer viewing through the pupil 732, in the example embodiment of FIG. 7.

Reference numbers 716 and 730 shows, qualitatively, where an image of the SLM 706 is optionally formed, in the example embodiment of FIG. 7.

In some embodiments a location of a pupil of the display 736 is optionally optically designed to be at reference number 716 in the example embodiment of FIG. 7.

In some embodiments, the image 716 of the SLM 706 is optionally at or next to the optional focusing lens 718, and the holographic image formed by such a system is termed a Fourier holographic image.

In some embodiments additional components 720 for tracking the pupil 732 of a viewer are optionally included in the HMD 701. Such components and their operation are described in detail in PCT patent application number IL2017/050226 of Gelman et al.

In some embodiments one or more zero-order blocking component(s) may be included the optical system of the HMD 701. In some embodiments, a zero-order blocking component may be a transparent glass with a dark spot located at the optical axis of the HMD 701, optionally placed, by way of a non-limiting example, between the optional first optical element 710 and the optional second optical element 714. Descriptions of additional optional embodiments of zero-order blocking may be found, inter alia, in PCT patent application number IL2017/050228 of Gelman et al.

A Computer Generated Holographic (CGH) image can be a perfect 3D display, which has all visual depth cues, including vergence and eye focus accommodation. However, displaying a CGH image requires computational and hardware complexity. In some embodiments, taking into account that a human eye has poor depth resolution (depth of focus) in image portions away from where the human eye fovea is looking, and that objects at distance greater than approximately 2 meters cause the human eye no significant eye accommodation, it can be simpler to display distant (>2 meters from an eye) images and images outside the fovea field-of-view by a 2D stereoscopic display or by a flat non-3D display. In some embodiments, a CGH image only presents a portion of an entire scene in focus, the portion which is in proximity to a viewer's eye (<2 meters) or within the fovea filed-of-view.

An example embodiment of a simple form of realizing a wide field of view with dual displays is now described:

A table top display screen is placed behind an apparent location of a CGH image. A computer monitors a location of the CGH image and a direction of a field of view of a viewer with respect to the location of the screen. Images for display by the screen are generated with respect to the apparent location of a CGH image.

In another embodiment the screen is optionally a stereoscopic display. In such a configuration a 3D display displaying the CGH image, by way of a non-limiting example a Head Mounted Display (HMD), optionally include a polarizer to block each eye from seeing the other eye's stereoscopic image. In such a configuration, by way of a non-limiting example, image portions at distances from 1 meter and beyond, where focus accommodation plays little role, are presented by the table top stereoscopic display, while the CGH image displays image portions at distances closer than 1 meter, where the focus accommodation plays a larger role in human depth perception. This way an entire scene appears as 3D, and a viewer is provided with all depth cues the viewer can use.

In some embodiments scene portions in the CGH image and a non-CGH image are co-registered, that is, the scene portions are displayed using a common coordinate system, or compensating for the relative locations of the viewer, a first display, for example a CGH image display, and a second display, for example a non-CGH image display.

In some embodiments co-registration is optionally achieved by using position and/or orientation indicators placed on the above-mentioned screen whose location and/or orientation are monitored by sensors in the HMD.

In some embodiments co-registration is optionally achieved by using position and/or orientation indicators placed on the above-mentioned HMD whose location and/or orientation are monitored by sensors external to the HMD, optionally placed in proximity to the screen.

It is expected that during the life of a patent maturing from this application many relevant three-dimensional displays, head mounted displays and holographic displays will be developed and the scope of the terms three-dimensional display, head mounted display and holographic display are intended to include all such new technologies a priori.

As used herein the terms “approximate” and “about” in all their grammatical forms refer to □ 20%.

The terms “comprising”, “including”, “having” and their conjugates mean “including but not limited to”.

The term “consisting of” is intended to mean “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a unit” or “at least one unit” may include a plurality of units, including combinations thereof.

The words “example” and “exemplary” are used herein to mean “serving as an example, instance or illustration”. Any embodiment described as an “example or “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

1-40. (canceled)

41. A method of displaying a scene, comprising:
displaying a first portion of the scene in three dimensions to a central portion of a viewer's field-of-view using a first, three-dimensional, display;
displaying a second portion of the scene to a peripheral portion of the viewer's field-of-view using a second display.

42. A method according to claim 41, wherein the central portion of the viewer's field-of-view comprises a foveal portion of the viewer's field-of-view.

43. A method according to claim 41, wherein the central portion of the viewer's field-of-view comprises a central 20 degrees of the viewer's field-of-view.

44. A method according to claim 41, and further comprising detecting an eye gaze direction of the viewer and directing the first portion of the scene to the central portion of the viewer's field-of-view based on the eye gaze direction of the viewer.

45. A method according to claim 41, and further comprising coordinating the display of the first portion of the scene and the second portion of the scene to appear as part of the same scene by:
using a first coordinate system for displaying the first portion of the scene;
using a second coordinate system for displaying the second portion of the same scene; and
registering the first coordinate system to the second coordinate system.

46. A method according to claim 41, in which the first portion of the scene overlaps the second portion of the scene in azimuth.

47. A method according to claim 41, in which the first portion of the scene overlaps the second portion of the scene in elevation.

48. A method according to claim 41, and further comprising determining a first part of the scene that belongs to the first portion of the scene and a second part of the scene that belongs to the second portion of the scene based on a first distance of the first portion of the scene from the viewer being less than a specific distance and a second distance of the second portion of the scene being more than the specific distance.

49. A method according to claim 48, in which the specific distance is in a range between 0.1 meter and 2 meters.

50. A method according to claim 41, and further comprising determining a first part of the scene that belongs to the first portion of the scene and a second part of the scene that belongs to the second portion of the scene based on the first portion of the scene being a central portion of the scene relative to a direction of view of the viewer and the second portion of the scene being peripheral to the first portion.

51. The method according to claim 41, and further comprising using a first color map to display the first portion of the scene and a second color map to display the second portion of the scene.

52. The method according to claim 41, and further comprising:
monitoring at least a portion of a volume in space in which the first display apparently displays an object;
sending location data of a real object inserted into the volume to a computer; and
using the computer to coordinate displaying objects in the scene by the first display and the second display based, at least in part, on the location data of the inserted real object.

53. The method according to claim 41, wherein the first three-dimensional display comprises an augmented reality display arranged to display the first portion of the scene and the first three-dimensional display also enabling viewing the second portion of the scene.

54. A system with multiple displays, comprising:
a first, three-dimensional, display;
a second display; and
a computer for coordinating displaying a scene using the first display to display a first portion of the scene in three dimensions to a central portion of a viewer's field-of-view and using the second display to display a second portion of the scene to a peripheral portion of the user's field-of-view.

55. A system according to claim 54, wherein the first display is arranged to display the first portion of the scene to a foveal portion of the viewer's field-of-view.

56. A system according to claim 54, wherein the first display is arranged to display the first portion of the scene to a central 20 degrees of the viewer's field-of-view.

57. A system according to claim 54, wherein the first three-dimensional display device is comprised in a Head Mounted Display (HMD) and the second display device is comprised in the HMD.

58. A system according to claim 54, and further comprising an eye gaze direction detection component.

59. A system according to claim 54, and further comprising:
a location detection component for monitoring at least a portion of a volume in space in which the first display apparently displays the scene and for sending location data of a real object inserted into the volume to the computer,
wherein the computer is configured for coordinating display of objects in the scene by the first display and the second display based, at least in part, on the location data of the inserted real object sent by the location detection component.

60. A system according to claim 54, wherein the first three-dimensional display comprises an augmented reality display arranged to display the first portion of the scene and the first three-dimensional display also enables viewing the second portion of the scene.
